(19) United States
(12) Patent Application Publication
(10) Pub. No.: US 2004/0133294 A1
(43) Pub. Date: Jul. 8, 2004

(54) Defect alarm system and method

(76) Inventors: Wei-Ming Chen, Hsinchu (TW); Gi-Gin Lin, Hsinchu (TW); Chien-Yi Hsu, Hsinchu (TW)

Correspondence Address: RABIN & BERDO, P.C., Suite 500, 1101 14th Street, N.W., Washington, DC, 20005, US

(21) Appl. No.: 10/651,942

(22) Filed: Sep. 2, 2003

(30) Foreign Application Priority Data
Jan. 2, 2003 (TW) 092100074

(51) Int. Cl. G06F 19/00

(52) U.S. Cl. 700/110; 700/121

(57) ABSTRACT

To rapidly respond to successive abnormal defect events, a defect alarm system and method comprises counting the defect detection data from a defect scan station using a defect data analysis system and producing a trend chart for the defect detection data. A defect data analysis system analyzes the trend chart at a constant time frame and records the successive abnormal defect events to produce a defect alarm report, and an email system automatically sends out the defect alarm report to notice the responsible engineer timely. After receiving the notice, the engineer compares the received defect distribution map with those of known events in a defect pattern database to judge if the event is a known one to propose a policy.

### FIELD OF THE INVENTION

The present invention generally relates to a warning system and method in a semiconductor fab. More particularly, the present invention relates to a defect alarm system and method rapidly responding to successive abnormal defects for a semiconductor process.

### BACKGROUND OF THE INVENTION

In the process of manufacturing semiconductor wafers, generally defect scan stations are equipped after some process steps to detect the quantity and type of the defects caused by the equipment or process, and a typical flowchart is shown in FIG. 1. The products of a same type are scanned for defects in step S10 first, and then in the step S11 the defects of the products are counted if they exceed the predetermined threshold. If they did, step S13 is proceeded, otherwise don't care in step S12. Operators practice defect review to the products having defects exceeding the quantity threshold in step S13 and notify responsible engineer of the reviewed result in step S14. In step S15, the engineer notifies the person in charge of the related equipment to shutdown the machine in accordance with the reviewed result. After the defects are classified and their quantity is counted by the operators, the responsible engineer is notified and then to further check whether it is a single event or a successive abnormal event. This operation mode will delay the timing of the subsequent alarm for the events, especially due to unintended mistakes.

In the art proposed by Taiwan Pat. Gazette No. 331,650, improvement was made to the on-line and off-line defect detection analysis method and related equipment for semiconductor fabs. However, it is for the general workflow and the way thereof, and neither the follow-up policy after the defect events nor how to reduce the damages resulted from the defect events is disclosed.

Hence, it is desired a defect alarm system and method for rapidly responding to successive abnormal defects to reduce the yield loss.

### SUMMARY OF THE INVENTION

One object of the present invention is to provide a defect alarm system and method for rapidly responding to successive abnormal defects to reduce the yield loss.

Accordingly, an inventive defect alarm system will count for the defect detection data from the defect scan station using a defect data statistics system and produce a trend chart for the defect detection data. A defect data analysis system analyzes the trend chart of the defect detection data at a constant time frame, and when the defect quantity of a same type of products at a defect scan station exceeds the threshold for two or more successive lots, the defect data analysis system will record the data and produce a defect alarm report to be further automatically sent out to the responsible engineer in the predetermined timing by an email system. After receiving the notice, the responsible engineer can compares in time the defect distribution map of the successive abnormal event from the defect scan station with the defect distribution maps of known events stored in a defect pattern database to judge if the successive abnormal event is a known one.

An aspect of the present invention is that the responsible engineers will be notified of the occurrence of the successive abnormal events before the operators finish their defect review. If the abnormal event is not a known one, the operator can carry out the defect review in highest priority. Contrarily, if the event is a known one, the responsible engineer can immediately notify the person in charge of the related equipment to shutdown the machine without waiting for the result of the defect review, and thereby reducing the yield loss resulted from successive abnormal defect events.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is a flowchart of a conventional defect detection method;

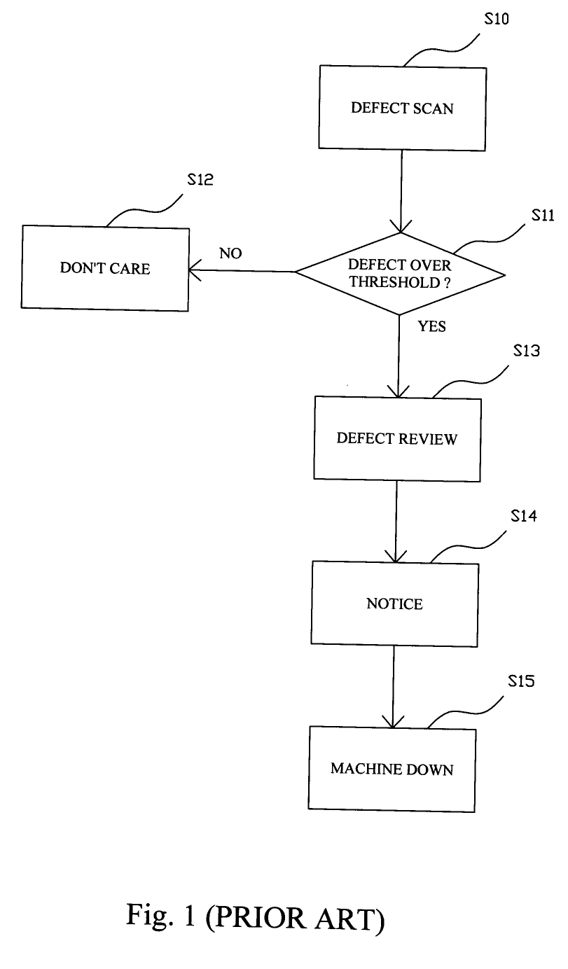

FIG. 2 is a diagram of a defect alarm system according to the present invention;

FIG. 3 is a trend chart of the defect detection data with the transverse axis in time and vertical axis in quantity;

FIG. 4 is a defect distribution map on a wafer; and

FIG. 5 is a flowchart of a defect alarm method according to the present invention.

### DETAIL DESCRIPTION OF THE INVENTION

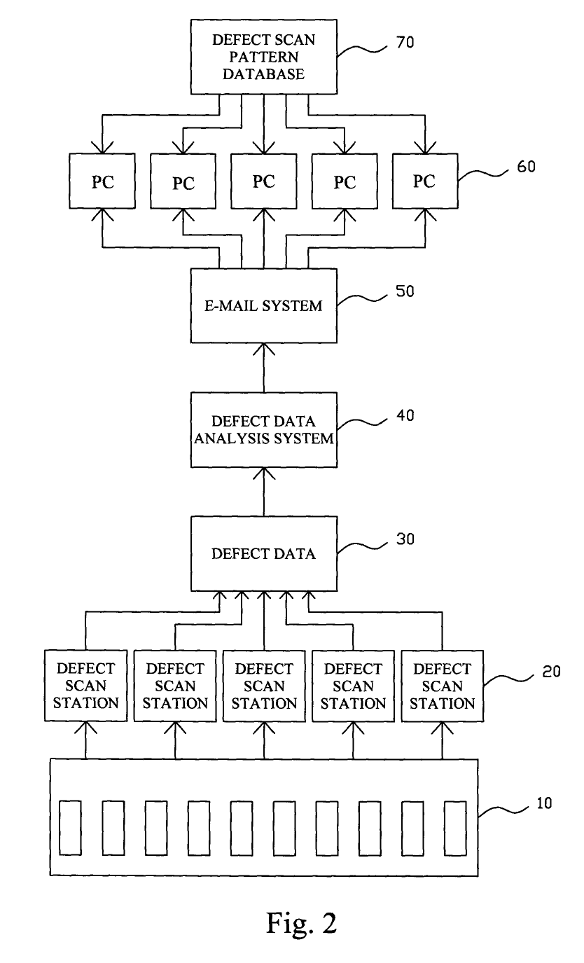

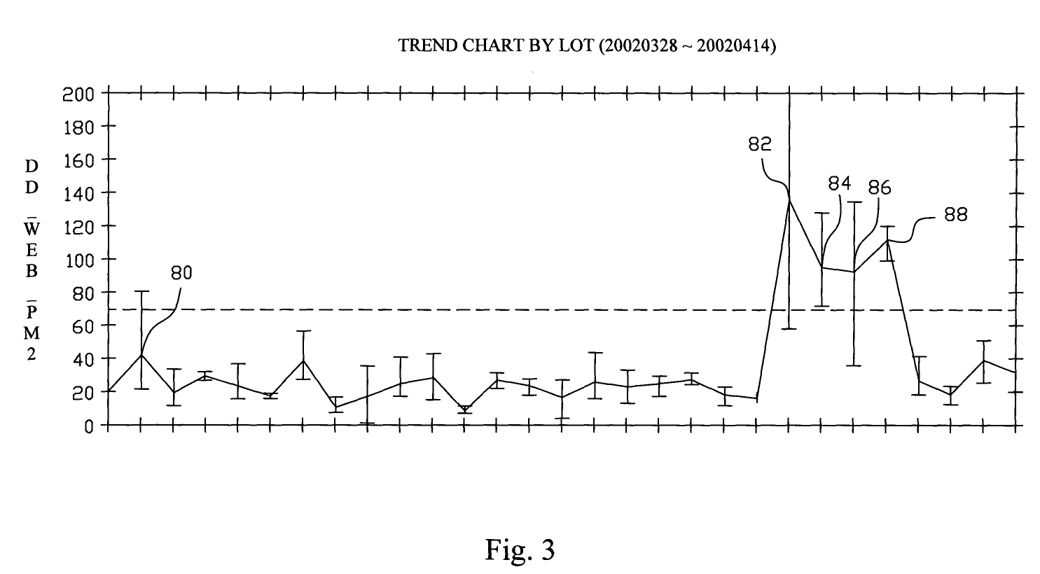

FIG. 2 is a diagram of a defect alarm system applied for defect detection to products according to the present invention, in which a production lines 10 transfer different type of products to the respective defect scan stations 20, each one of them scans the defect distribution of the products to produce a defect detection data and a defect distribution map. A defect data analysis system 30 counts the defect quantity from the defect detection data and produces a trend chart for the defect detection data based on the product process sequence. As shown in FIG. 3, according to the chart, the engineers can monitor if there is any abnormal event with the quantities of the defects. A defect data analysis system 40 further analyzes the trend chart of the defect detection data at a constant time frame to record the data for defect alarm report when two or more successive lots of the same type products have defects exceeding a predetermined threshold. As designated by 82, 84, 86 and 88 shown in FIG. 3, for example, the successive two or more lots of a same product type exceed the threshold, and the defect data analysis system 40 will record the data and produce the defect alarm report as shown in Table 1.

TABLE 1
Defect Scan Alarm REPORT

id Msc9046
by FA, 04/10/2002

| ROUTE | PROD | OPER | LOT_ID | Item1 | Item2 | Item3 |
|---|---|---|---|---|---|---|
| Route01 | Pr01 | 863357 | lot00001 | DD_WEB | | |
| Route01 | Pr01 | 863357 | lot00002 | DD_WEB | | |
| Route01 | Pr01 | 863357 | lot00003 | DD_WEB | | |
| Route01 | Pr01 | 863357 | lot00004 | DD_WEB | | |
| Route02 | Pr02 | 860597 | lot00005 | DC_ML1 | DD_{—} | |
| | | | | | ML1 | |
| Route02 | Pr02 | 860597 | 1ot00006 | DC_ML1 | DD_{—} | |
| | | | | | ML1 | |

Result of Data (Today 12:00 To Today 17:00)
Order by 1.)Route_ID 2.)Oper_No 3.)Reprt_Date 4.)Reprt_Time

In Table 1, Pr01 and Pr02 show two products occurred with successive abnormal defect events. FIG. 3 is an example for the product Pr01. In this table, the defects of four successive lots of the product Pr01 at the defect scan station 863357 successively exceed the threshold. An email system 50 automatically sends out the defect alarm report at a predetermined timing to a client computer 60 to notify the responsible engineer. After receiving the report, the responsible engineer compares the defect distribution map of the received event with the defect distribution maps of known events stored in a defect pattern database 70 to judge if the received event is a known one. If it is, the person in charge of the related equipment will be notified to shutdown the machine, otherwise, the operator will be noticed to practice defect review in highest priority for this defect event and then the person in charge of the related equipment will be notified to shutdown the machine according to the result of the defect review. In the later case, i.e., for unknown event, the defect distribution map and the result of the defect review are further stored to update the defect pattern database 70, such that rapid response can be made without waiting for defect review for the same events in future. This system provides the advantages that the engineer can be early noticed of the known defect events before the operators finish the defect review and propose the policy for trouble shooting in advance, thereby reducing the yield loss.

FIG. 3 is the trend chart of the defect detection data produced by the defect data analysis system 30 by counting the defect detection data of a same defect scan station 20 based on the product process sequence, on which there are 5 lots of products 80, 82, 84, 86 and 88 exceeding the defect quantity threshold. However, the lot 80 represents a single event, and it is thus not recorded in the defect alarm report. In contrast, the lots 82, 84, 86 and 88 show that they are successive events, so that the data for these four lots are recorded in the defect alarm report, as shown in Table 1.

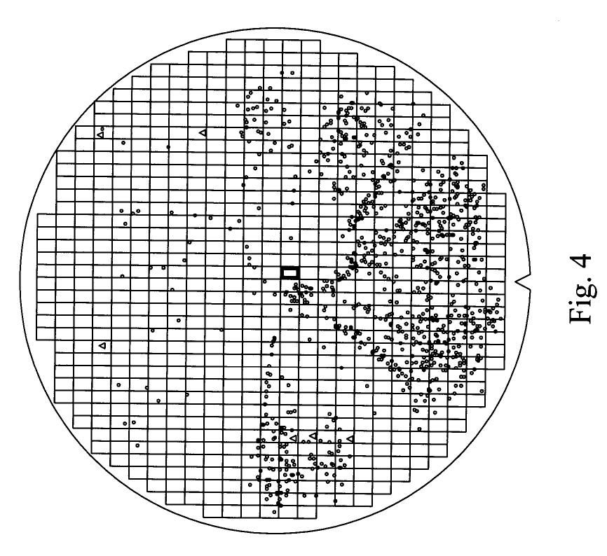

FIG. 4 shows a sample of a typical defect distribution map scanned on a wafer, on which the black dots are defective regions. The defect distribution map has a respective aspect corresponding to one or more specific defect types and therefore indicates a specific defect event, and by which the engineers can judge each known defect event.

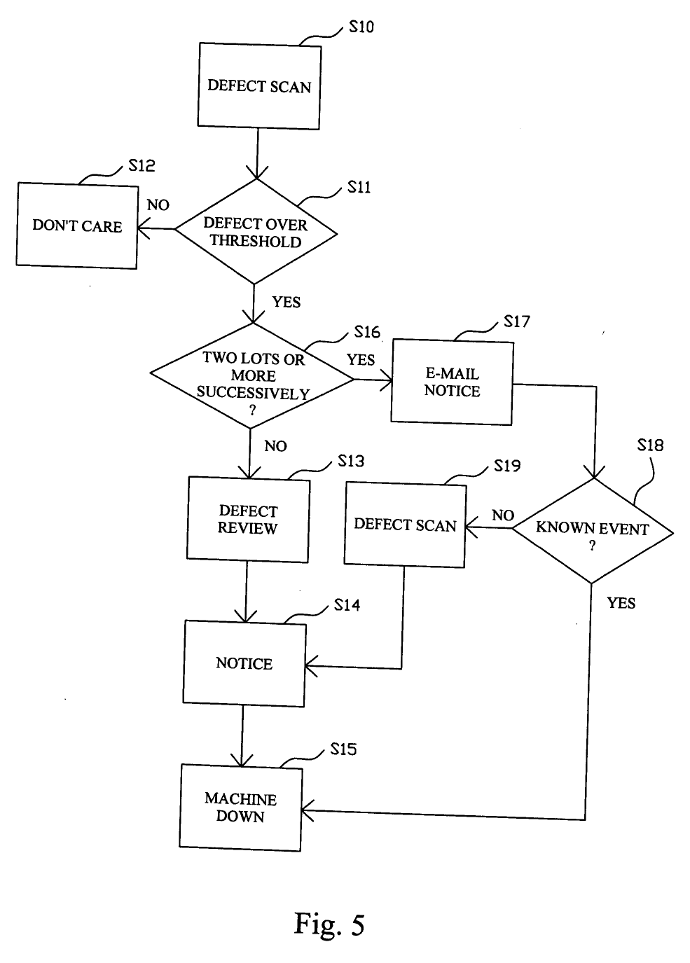

FIG. 5 is a flowchart of a defect detection method according to the present invention, by which a defect scan is performed to the products in step S10 and then in step 11 the defect quantity of the products is counted to check if it exceeds the threshold. If it does, then step S16 is proceeded, otherwise don't care in step S12. The step S16 is to judge if there are two or more lots of products have the defect quantity exceeding the threshold, and if it is true, then step S17 is proceeded, otherwise step S13 is performed. In step S13, the operator practices defect review to the products, followed with step 14 to notify the responsible engineer of the review result. In step S15, the engineer notifies the person in charge of the equipment to shutdown the machine in accordance with the result of the defect review. In step S17, the product data of the successive defect events is automatically sent out to the responsible engineer. In step 18, the responsible engineer judges if the successive defect event is a known one, and if it is, then step S19 is proceeded, otherwise goes to step S15. In step S19, the operator practices defect review for the successive defect events in highest priority, and then steps S14 and S15 are performed sequentially. The successive abnormal events can be notified as early as possible by the inventive system and method, and by which, the unknown abnormal events are treated as conventionally by defect review, and for each known one, the person in charge of the equipment can be early notified to shutdown the machine to thereby reduce the yield loss.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A defect alarm system for rapidly responding to successive abnormal defect events, comprising:
a defect scan station for scanning a defect distribution for a type of products to thereby produce a defect detection data and a defect distribution map;
a defect data statistics system for counting a defect quantity from the defect detection data and generating a trend chart for the defect detection data;
a defect data analysis system for analyzing the trend chart at a constant time frame and making a record when defet counts of two or more successive lots exceed a threshold to thereby induce a defect alarm report;
an email system for sending out the defect alarm report in a predetermined timing; and
a defect pattern database for storing a plurality of defect distribution maps of known events to be compared with the defect distribution map.

2. A defect alarm method for rapidly responding to successive abnormal defect events, comprising the steps of:
scanning a type of products for producing a defect detection data and a defect distribution map;
counting a defect quantity from the defect detection data and generating a trend chart for the defect detection data;
analyzing the trend chart at a constant time frame and making a record when defect counts of two or more successive lots exceed a threshold to thereby induce a defect alarm report; and
sending out the defect alarm report automatically by an email system.

3. The method of claim 2, further comprising comparing the defect distribution map with a defect pattern database.

4. The method of claim 3, further comprising sending out a machine shutdown notice when the defect distribution map corresponds to a known event.

5. The method of claim 3, further comprising sending out a scan review notice when the defect distribution map corresponds to an unknown event and then sending out a machine shutdown notice in accordance with the result of the scan review.
